(19) United States
(12) Patent Application Publication
(10) Pub. No.: US 2018/0118621 A1
(43) Pub. Date: May 3, 2018

(54) METHODS FOR STRENGTHENING PERLITE MICROSPHERES, AND FLUIDS AND CEMENTS INCLUDING STRENGTHENED PERLITE MICROSPHERES

(71) Applicant: Imerys Filtration Minerals, Inc., San Jose, CA (US)

(72) Inventors: Bo WANG, Union City, CA (US); Michael GREENHILL-HOOPER, Miradoux (FR)

(21) Appl. No.: 15/570,755

(22) PCT Filed: Apr. 28, 2016
(86) PCT No.: PCT/US2016/029809

§ 371 Date: Oct. 31, 2017

Related U.S. Application Data
(60) Provisional application No. 62/155,773, filed on May 1, 2015.

(51) Int. Cl. C04B 20/06; C04B 14/18; C04B 28/02; C09K 8/467; C09K 8/03

(52) U.S. Cl. CPC C04B 20/068; C04B 14/18; C04B 20/06; C04B 2201/50; C09K 8/467; C09K 8/032; C04B 28/02

(57) ABSTRACT

A method for strengthening perlite microspheres may include providing a plurality of perlite microspheres, and heating the plurality of perlite microspheres at a temperature of at least about 600° C. for at least about five minutes to form strengthened perlite microspheres. A composition may include the strengthened perlite microspheres formed from the above-noted method. At least one of a drilling fluid and a well cement may include a slurry including at least one fluid, and a composition including strengthened perlite microspheres. A slurry may include at least one fluid and a plurality of perlite microspheres. The plurality of perlite microspheres may be strengthened by at least one of (1) heating the plurality of perlite microspheres at a temperature of at least about 600° C. for at least about five minutes: and (2) adding at least one metal component and at least one silicate component to the plurality of perlite microspheres.

### CLAIM OF PRIORITY

This PCT International Application claims the benefit of priority of U.S. Provisional Application No. 62/155,773, filed May 1, 2015, the subject matter of which is incorporated herein by reference in its entirety.

### FIELD OF THE DESCRIPTION

This disclosure is related to methods for strengthening perlite microspheres, and fluids and cements including strengthened perlite microspheres.

### BACKGROUND

Particulate mineral materials find use in a variety of different applications including, but not limited to, coatings, pigments, fillers, proppants, catalysts, extenders, inert carriers, for filtration, for insulations, and for horticultural applications. One example of a particulate mineral material is perlite. Perlite is a naturally occurring siliceous volcanic glass rock, generally distinguishable from other volcanic glasses due to its expansion from about four to about twenty times its original volume when heated to a temperature within its softening range. Perlite is a hydrated material that may contain, for example, about 72 to about 75% SiO₂, about 12 to about 14% Al₂O₃, about 0.5 to about 2% Fe₂O₃, about 3 to about 5% Na₂O, about 4 to about 5% K₂O, about 0.4 to about 1.5% CeO (by weight), and trace amounts of other metallic elements. Perlite particles have been found to be useful in a variety of applications, such as those mentioned above, both in their expanded and in their unexpanded form. For example, perlite microspheres may be used in fluids (e.g., in slurries), such as, for example, drilling fluid and well cement.

For example, drilling fluid may be used to aid the drilling of boreholes into the earth, for example, when drilling oil and natural gas wells. Drilling fluid may be used, for example, to provide hydrostatic pressure to prevent formation fluids from entering the well bore, to inhibit heat and cuttings build-up on the drill during drilling, to carry out drill cuttings, and to suspend the drill cuttings while drilling is paused. Well cement may be introduced into the annular space between the well bore and the casing, which surrounds the drill bit, or into the annular space between two successive casing strings.

Well cement may generally be used, for example, to support the vertical and radial loads applied to the casing, isolate porous formations from the producing zone formations, protect the casing from corrosion, and confine abnormal pore pressure. Perlite microspheres may be used in oil well cementing applications as cement extenders, and may be used to reduce the density of the well cement. In some environments, it may be desirable to control cement density. For example, in long cement columns encountered in deep wells, for example, in deep sea wells, it may be desirable to reduce well cement density from its customary value of about 16 pounds per gallon to about 8 to 9 pounds per gallon, to prevent the heavy weight of the dense cement column from fracturing weak rock formations, often found just below the ocean floor. It may also be desirable to have a low density well cement so that a well may be cemented in a single stage, rather than in multiple stages, which saves time and money.

The expanded form of perlite may be achieved due in part to the presence of water trapped within the crude perlite glass rock. When perlite is quickly heated, the water vaporizes, creating bubbles in the heat-softened glassy particles and generally resulting in a light-weight, chemically inert, highly expanded perlite product. An expanded perlite product may be manufactured to weigh from, for example, about 2 pounds per cubic foot to about 15 pounds per cubic foot, allowing it to be adapted for numerous uses, such as those previously described.

The final form and grade of an expanded perlite product may be controlled by, among other things, changing the heating cycle within a perlite expander and/or altering the size profile of an unexpanded perlite feed material by milling or other processes known to those skilled in the art. In expanded forms, the perlite particles may be solid microspheres or hollow microspheres. Expanded perlite in the form of hollow microspheres may generally have fewer inner cells as compared to the relatively larger number of inner cells found in the more commonly produced expanded perlite aggregate particles.

For some uses, increasing the compressive strength, hardness, and/or color of perlite microspheres may desirable. For example, it may be desirable for some uses to strengthen perlite microspheres by, for example, increasing their compaction strength and/or related characteristics to improve performance.

### SUMMARY

In accordance with a first aspect, a method for strengthening perlite microspheres may include providing a plurality of perlite microspheres, and heating the plurality of perlite microspheres at a temperature of at least about 600° C. for at least about five minutes to form strengthened perlite microspheres.

According to a further aspect, a composition may include the strengthened perlite microspheres formed from the above-noted method. For example, at least one of a drilling fluid and a well cement may include a slurry including at least one fluid, and the above-noted composition including strengthened perlite microspheres.

According to yet another aspect, a slurry for use as at least one of a drilling fluid and a well cement may include at least one fluid, and a plurality of perlite microspheres. The plurality of perlite microspheres may be strengthened by at least one of (1) heating the plurality of perlite microspheres at a temperature of at least about 600° C. for at least about five minutes to provide heat-treated perlite microspheres having reduced surface flaws relative to the perlite microspheres prior to heat treating; and (2) adding at least one metal component and at least one silicate component to the plurality of perlite microspheres to form a plurality of metal silicate-coated perlite microspheres,

According to still a further aspect, treated perlite microspheres may include at least one of (1) heat-treated perlite microspheres heated at a temperature of at least about 600° C. for at least about five minutes to provide heat-treated perlite microspheres having reduced surface flaws relative to the perlite microspheres prior to heat treating; and (2) surface-treated perlite microspheres including a plurality of metal silicate-coated perlite microspheres. The treated perlite microspheres may have a density of less than 1.5 grams per cubic centimeter and a crush strength of less than 50% volume collapsed at 10000 pounds per square inch, The treated perlite microspheres may have a median particle size (d₅₀) between about 1 pm and 200 μm.

### BRIEF DESCRIPTION OF THE DRAWINGS

FIG. 1 is an SEM Micrograph of an example of a perlite microsphere prior to heating.

FIG. 2 is an SEM Micrograph of an example of a perlite microsphere following heating.

FIG. 3 is a graph showing compaction resistance of exemplary perlite microsphere samples following heating at 950° C. for thirty minutes and treatment with boric acid, as a function of boric acid concentration.

FIG. 4 is a graph showing compaction resistance of exemplary perlite microsphere samples following heating and treatment with a 10% boric acid concentration, as a function of temperature.

FIG. 5 is a graph showing the percentage of void volume (% void volume) collapse as a function of pressure for example microsphere samples.

FIG. 6 is a graph showing the percentage of void volume (% void volume) collapse and density at a pressure of 5000 pounds per square inch (psi) for the example microsphere samples shown in FIG. 5.

### DESCRIPTION OF EXEMPLARY EMBODIMENTS

According to some embodiments, a method for strengthening perlite microspheres may include providing a plurality of perlite microspheres, and heating the plurality of perlite microspheres at a temperature of at least about 600° C. for at least about five minutes to form strengthened perlite microspheres. For example, the perlite microspheres may be heated at a temperature of at least about 800° C. for at least about five minutes, at a temperature of at least about 900° C. for at least about five minutes, at a temperature of at least about 1000° C. for at least about five minutes, at a temperature of at least about 1100° C. for at least about five minutes, or at a temperature of at least about 1200° C. for at least about five minutes. According to some embodiments, the heating may occur for at least about ten minutes, at least about fifteen minutes, at least about twenty minutes, at least about twenty-five minutes, or at least about thirty minutes.

According to some embodiments, the perlite microspheres may be formed by heating perlite particles. Thereafter, the heated perlite microspheres may be cooled, for example, to room temperature in ambient air. According to some embodiments, the cooled perlite microspheres may thereafter be heat-treated, for example, as described herein, to form strengthened perlite microspheres,

Without wishing to be bound by theory, it is believed that heating the perlite microspheres increases the strength (e.g., the compaction strength) of the perlite microspheres by removing and/or reducing flaws (e.g., cracks and pores) in the surface of the perlite microspheres. For example, the surface flaws may be reduced by heating the perlite microspheres at a sufficient temperature for a sufficient duration to soften the surface of the perlite microspheres. According to some embodiments, the heating may be sufficient to cause the perlite microspheres to soften.

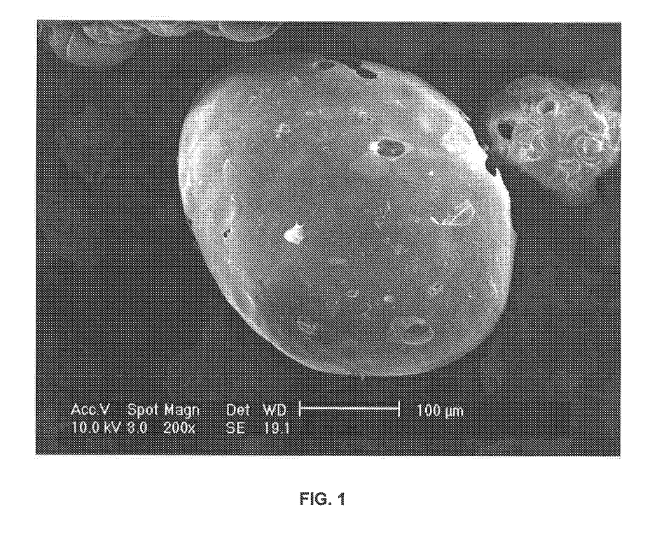

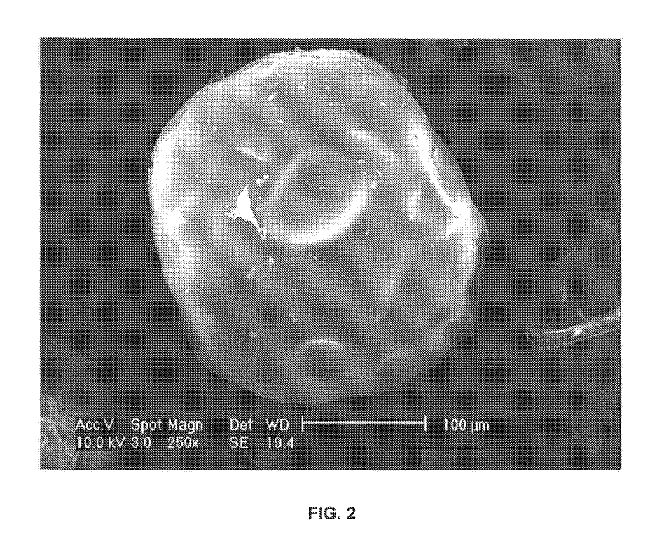

For example, FIG. 1 is an SEM Micrograph of an example of a perlite microsphere prior to heating. FIG. 2 is an SEM Micrograph of an example of a perlite microsphere following heating. Comparing the perlite microsphere shown in FIG. 1 to the heat-treated perlite microsphere shown in FIG. 2, the heat-treated perlite microsphere has relatively fewer surface flaws (e.g., cracks and pores). This reduction in flaws is believed to increase the strength (e.g., the compaction strength) by reducing the number of sites where fractures may propagate.

As used herein, the term “microsphere” refers to a sphere or spherical material that is micron in scale. As used herein, the prefix “micro” and the term “micron scale” both refer to a perlite microsphere having an equivalent spherical diameter of less than 100 micrometers (microns). As used herein, a particulate mineral material may be considered “micron scale,” even though it may have some individual particles that have agglomerated, thereby forming non-micron scale agglomerates in the otherwise micron scale material, or are otherwise non-micron scale.

As used herein, the terms “sphere” or “spherical” refer to a particle that, when magnified as a two-dimensional image, generally appears rounded and generally free of sharp corners or edges, whether or not the particle appears to be truly or substantially circular, elliptical, globular, or any other rounded shape. As a result, in addition to truly circular and elliptical shapes, other shapes with curved but not circular or elliptical outlines are considered as being a “sphere” or being as “spherical.” A particulate form of perlite may also be considered to be a “sphere” or as being “spherical,” even though it may have some individual particles that have agglomerated, thereby forming non-spherical agglomerates in the otherwise spherical material, or are otherwise non-spherical.

According to some embodiments, the perlite microspheres may have a one-inch compaction strength prior to being strengthened, and the strengthened perlite microspheres may a one-inch compaction strength at least twice the one-inch compaction strength of the perlite microspheres prior to being strengthened. For example, the strengthened perlite microspheres have a one-inch compaction strength at least four times the one-inch compaction strength of the perlite microspheres prior to being strengthened, a one-inch compaction strength at least eight times the one-inch compaction strength of the perlite microspheres prior to being strengthened, or, for example, a one-inch compaction strength at least thirty times the one-inch compaction strength of the perlite microspheres prior to being strengthened.

According to some embodiments, the strengthened perlite microspheres may have an average diameter less than or equal to about 300 microns. For example, the strengthened perlite microspheres may have an average diameter less than or equal to about 200 microns, less than or equal to about 100 microns, or less than or equal to about 50 microns.

According to some embodiments, the perlite microspheres may have a tamped density before compaction prior to being strengthened, and the strengthened perlite microspheres may have a tamped density before compaction ranging from about 5 pounds per cubic foot to about 35 pounds per cubic foot, such as, for example, about 10 pounds per cubic foot to about 25 pounds per cubic foot, or from about 15 pounds per cubic foot to about 25 pounds per cubic foot.

According to some embodiments, a method for strengthening perlite microspheres may include providing a plurality of perlite microspheres, and adding at least one metal component and at least one silicate component to the plurality of perlite microspheres to form a plurality of metal silicate-coated perlite microspheres. According to some embodiments, the addition of at least one metal component and at least one silicate component may be performed without also heating the perlite microspheres to strengthen them, According to some embodiments, the addition of at least one metal component and at least one silicate component may be performed before heating the perlite microspheres. According to some embodiments, the addition of at least one metal component and at least one silicate component may be performed after heating the perlite microspheres.

According to some embodiments, the at least one metal component may be selected from the group consisting of metal nitrates, metal sulfates, metal aluminates, sodium metals, metal chlorides, metal alkoxides, metal acetates, metal formates, bayerite, pseudoboehmite, gibbsite, colloidal metals, metal gels, metal sols, metal trichlorides, ammonium metal carbonates, metal hydrates, and metal chiorohydrates. According to some embodiments, the at least one metal component may include at least one of aluminum, boron, lithium, zinc, and zirconium. According to some embodiments, the at least one silicate component may be selected from the group consisting of tetraethylorthosilicate, tetramethylorthosilicate, sodium silicate, alkali silicate, colloidal silica, solid silica, alkaline metal silicates, and sodium metasilicate, According to some embodiments, the perlite microspheres may be strengthened with at least one of boroaluminosilicate and lithium aluminosilicate.

A composition may include the strengthened perlite microspheres, for example, formed from the methods disclosed herein. According to some embodiments, the perlite microspheres may have an average diameter of at least about 10 micrometers (microns). For example, the perlite microspheres may have an average diameter of at least about 30 microns, at least about 40 microns, at least about 60 microns, or at least about 80 microns. According to some embodiments, the perlite microspheres may have an average diameter of about 10 microns to about 3 mm, an average diameter of about 10 microns to about 2 mm, or an average diameter from about 10 microns to about 1.7 mm. According to some embodiments, the perlite microspheres may have an average diameter of 0.089 millimeters to about 3 mm, which corresponds generally to a mesh size of about 6 to about 170 mesh. in some embodiments, the perlite microspheres may have an average diameter of about 0.1 mm to about 3 mm, which corresponds generally to a mesh size of about 6 to about 140 mesh. In some embodiments, the perlite microspheres may have an average diameter from about 0.2 mm to about 2 mm, which corresponds generally to about 10 to about 80 mesh, According to some embodiments, the perlite microspheres may have an average diameter from about 0.2 mm to about 1.7 mm, which corresponds generally to about 12 to about 80 mesh. The selection of microsphere size may depend on various considerations, such as, for example, desired use and/or other similar factors.

Particle size may be measured by any appropriate measurement technique now known to the skilled artisan or hereafter discovered. In one exemplary method, particle size and particle size properties, such as particle size distribution (“psd”), are measured using a Leeds and Northrup Microtrac X100 laser particle size analyzer (Leeds and Northrup, North Wales, Pa., USA), which can determine particle size distribution over a particle size range from 0.12 μm to 704 μm. The size of a given particle is expressed in terms of the diameter of a sphere of equivalent diameter that sediments through the suspension, also known as an equivalent spherical diameter or “esd.” The median particle size, or d₅₀ value, is the value at which 50% by weight of the particles have an esd less than that d₅₀ value.

In some embodiments, the perlite microspheres may have a median particle size (d₀) less than about 200 μm, less than about 150 μm, less than about 100 μm, or less than about 80 μm. Some embodiments may include perlite microspheres having a median particle size (d₅₀) greater than about 1 μm or greater than about 10 μm. Some embodiments may, for example, include perlite microspheres having a median particle size (d₅₀) between about 1 μm and about 200 μm; between about 1 μm and about 150 μm; between about 1 μm and about 100 μm; or between about 1 μm and about 80 μm. The perlite microspheres may also have, for example, a median particle size (d₅₀ ) between about 10 μm and about 200 μm; between about 10 μm and about 150 μm; between about 10 μm and about 100 μm, or between about 10 μm and about 80 μm.

A fluid, such as, for example, a drilling fluid or a well cement may include a slurry including at least one fluid, such as, for example, water and/or oil, and a composition including strengthened perlite microspheres. For example, the plurality of perlite microspheres of the slurry may be strengthened by at least one of (1) heating the plurality of perlite microspheres at a temperature of at least about 600° C. for at least about five minutes to provide heat-treated perlite microspheres having reduced surface flaws relative to the perlite microspheres prior to heat treating; and (2) adding at least one metal component and at least one silicate component to the plurality of perlite microspheres to form a plurality of metal silicate-coated perlite microspheres.

For example, the perlite microspheres of the slurry may be heated at a temperature of at least about 800° C. for at least about five minutes, at a temperature of at least about 900° C. for at least about five minutes, at a temperature of at least about 1000° C. for at least about five minutes, at a temperature of at least about 1100° C. for at least about five minutes, or at a temperature of at least about 1200° C. for at least about five minutes. According to some embodiments, the heating may occur for at least about ten minutes, at least about fifteen minutes, at least about twenty minutes, at least about 25 minutes, or at least about thirty minutes.

According to some embodiments, for the plurality of perlite microspheres of the slurry, the at least one metal component and at least one silicate component may be added to the plurality of perlite microspheres to form a plurality of metal silicate-coated perlite microspheres. For example, the at least one metal component may be selected from the group consisting of metal nitrates, metal sulfates, metal aluminates, sodium metals, metal chlorides, metal alkoxides metal acetates, metal formates, bayerite, pseudoboehmite, gibbsite, colloidal metals, metal gels, metal sols, metal trichlorides, ammonium metal carbonates, metal hydrates, and metal chlorohydrates. According to some embodiments, the at least one metal component may include at least one of aluminum, boron, lithium, zinc, and zirconium. According to some embodiments, the at least one silicate component may be selected from the group consisting of tetraethylorthos licate, tetramethylorthosilicate, sodium silicate, alkali silicate, colloidal silica, solid silica, alkaline metal silicates, and sodium metasilicate. According to some embodiments, the perlite microspheres may be strengthened with at least one of boroaluminosilicate and lithium aluminosilicate.

According to some embodiments, the strengthened perlite microspheres of the slurries may have a one-inch compaction strength of at least 5 pounds per square inch. For example, the strengthened perlite microspheres may have a one-inch compaction strength of at least 10 pounds per square inch, at least 20 pounds per square inch, at least 30 pounds per square inch, at least 40 pounds per square inch, at least 50 pounds per square inch, at least 60 pounds per square inch, at least 70 pounds per square inch, at least 80 pounds per square inch, at least 90 pounds per square inch, or, for example, at least 100 pounds per square inch. According to some embodiments, the strengthened perlite microspheres of the slurries may have a tamped density before compaction of at least 4 pounds per cubic foot. For example, the strengthened perlite microspheres may have a tamped density before compaction of at least 6 pounds per cubic foot, at least 10 pounds per cubic foot, or at least 15 pounds per cubic foot. According to other embodiments, the perlite microspheres may have a tamped density before compaction prior to being strengthened, and the strengthened perlite microspheres may have a tamped density before compaction ranging from about 5 pounds per cubic foot to about 35 pounds per cubic foot, such as, for example, about 10 pounds per cubic foot to about 25 pounds per cubic foot, or from about 15 pounds per cubic foot to about 25 pounds per cubic foot.

According to some embodiments, treated perlite microspheres may include at least one of (1) heat-treated perlite microspheres heated at a temperature of at least about 600° C. for at least about five minutes to provide heat-treated perlite microspheres having reduced surface flaws relative to the perlite microspheres prior to heat treating; and (2) surface-treated perlite microspheres comprising a plurality of metal silicate-coated perlite microspheres. According to some embodiments, the treated perlite microspheres may have a density of less than 1.5 grams per cubic centimeter and a crush strength of less than 50% volume collapsed at 10000 pounds per square inch. For example, the treated perlite microspheres may have a density of less than 1.0 gram per cubic centimeter and a crush strength of less than 50% volume collapsed at 10000 pounds per square inch, or less than 0.5 grams per cubic centimeter and a crush strength of less than 50% volume collapsed at 10000 pounds per square inch. According to some embodiments, the treated perlite microspheres may have a density of less than 1.5 grams per cubic centimeter and a crush strength of less than 50% volume collapsed at 8000 pounds per square inch, For example, the treated perlite microspheres may have a density of less than 1.0 gram per cubic centimeter and a crush strength of less than 50% volume collapsed at 8000 pounds per square inch, or less than 0.5 grams per cubic centimeter and a crush strength of less than 50% volume collapsed at 8000 pounds per square inch. According to some embodiments, the treated perlite microspheres may have a density of less than 1.5 grams per cubic centimeter and a crush strength of less than 50% volume collapsed at 5000 pounds per square inch. For example, the treated perlite microspheres may have a density of less than 1.0 gram per cubic centimeter and a crush strength of less than 50% volume collapsed at 5000 pounds per square inch, or less than 0.5 grams per cubic centimeter and a crush strength of less than 50% volume collapsed at 5000 pounds per square inch.

According to some embodiments, the treated perlite microspheres may include heat-treated perlite microspheres heated at a temperature of at least about 800° C. for at least about five minutes, for example, at a temperature of at least about 900° C. for at least about five minutes, at a temperature of at least about 1000° C. for at least about five minutes, a temperature of at least about 1100° C. for at least about five minutes, or a temperature of at least about 1200° C. for at least about five minutes. According to some embodiments, the heating may occur for at least about ten minutes, at least about fifteen minutes, at least about twenty minutes, at least about twenty-five minutes, or at least about thirty minutes.

According to some embodiments, the treated perlite microspheres may include surface-treated perlite microspheres, and the metal silicate coating may include at least one metal component selected from the group consisting of metal nitrates, metal sulfates, metal aluminates, sodium metals, metal chlorides, metal alkoxides, metal acetates, metal formates, bayerite, pseudoboehmite, gibbsite, colloidal metals, metal gels, metal sols, metal trichlorides, ammonium metal carbonates, metal hydrates, and metal chlorohydrates. According to some embodiments, the at least one metal component may include at least one of aluminum, boron, lithium, zinc, and zirconium. According to some embodiments, the at least one silicate component may be selected from the group consisting of tetraethylorthosilicate, tetramethylorthosilicate, sodium silicate, alkali silicate, colloidal silica, solid silica, alkaline metal silicates, and sodium metasilicate. According to some embodiments, the perlite microspheres may be strengthened with at least one of boroaluminosilicate and lithium aluminosilicate.

According to some embodiments, the reinforcement coating process may include providing a coating solution by mixing metal compound and metal silicate in water, spraying the coating solution onto the perlite microsphere surface, and thereafter drying the coated samples in an oven at, for example, 150° C.

According to some embodiments, the at least one metal component may comprise from about zero percent (or trace amounts) to about 25% of the coating solution, such as, for example, from about zero percent to about 20%, from about zero percent to about 15%, from about zero percent to about 10%, or from about zero percent to about 5%. According to some embodiments, the at least one metal silicate component may comprise from about 1% to about 35% of the coating solution, such as, for example, from about 1% to about 30%, from about 1% to about 25%, from about 1% to about 20%, from about 1% to about 15%, from about 1% to about 10%, or from about 1% to about 5%.

According to some embodiments, the treated perlite microspheres may have a one-inch compaction strength of at least 5 pounds per square inch. For example, the strengthened perlite microspheres may have a one-inch compaction strength of at least 10 pounds per square inch, at least 20 pounds per square inch, at least 30 pounds per square inch, at least 40 pounds per square inch, at least 50 pounds per square inch, at least 60 pounds per square inch, at least 70 pounds per square inch, at least 80 pounds per square inch, at least 90 pounds per square inch, or, for example, at least 100 pounds per square inch. According to some embodiments, the strengthened perlite microspheres of the slurries may have a tamped density before compaction of at least 4 pounds per cubic foot. For example, the strengthened perlite microspheres may have a tamped density before compaction of at least 6 pounds per cubic foot, at least 10 pounds per cubic foot, or at least 15 pounds per cubic foot. According to other embodiments, the perlite microspheres may have a tamped density before compaction prior to being strengthened, and the strengthened perlite microspheres may have a tamped density before compaction ranging from about 5 pounds per cubic foot to about 35 pounds per cubic foot, such as, for example, about 10 pounds per cubic foot to about 25 pounds per cubic foot, or from about 15 pounds per cubic foot to about 25 pounds per cubic foot.

According to at least some surface-treated embodiments, the perlite microspheres may be coated with at least one coating, wherein the at least one coating may take the form of a glassy-type coating. In some embodiments, the at least one coating may take the form of a ceramic-type coating and/or a sol-gel type coating.

According to some surface-treated embodiments, the at least one metal component may be applied to the perlite microspheres separately and directly, forming a coating including at least one metal component thereon. In some embodiments, the starting materials of the at least one metal component may first be mixed or reacted, and thereafter, applied to the perlite microspheres to form at least one coating. In some embodiments, the at least one metal component, or one or more starting materials of the at least one metal component, including mixtures of starting materials, may be applied to the perlite microspheres by being sprayed onto the surface of the perlite microspheres. In some embodiments, the at least one metal component may be applied to the perlite microspheres by solution coating. For example, in some embodiments, the solution coating may be performed at or about room temperature (e.g., about 70° F.). In some embodiments, the solution coating may be performed at a temperature less than about 300° F. or less than about 150° F.

In some embodiments, the at least one metal component and the at least one silicate component, either individually or as a mixture, may be applied to the perlite microspheres while the perlite microspheres are at an elevated temperature relative to room temperature. In some embodiments, the at least one metal component may be applied to the perlite microspheres while being expanded and while at an elevated temperature. In some embodiments, the at least one metal component may be applied to the perlite microspheres after they have been expanded and while at an elevated temperature. For example, the elevated temperature may be from about 900° F. to about 1500° F.

The heat-treated and/or surface-treated perlite microspheres may exhibit increased hardness. compressive strength, and/or improved coloration over perlite microspheres that are not subjected to the heat-treatment and/or surface-treatment below.

### EXAMPLES

Several examples consistent with the exemplary embodiments disclosed herein are described below.

Commercially available perlite microsphere product samples (Harborlite® 50×50, available from Imerys) were heat-treated at a temperature ranging from 800° C. to 1000° C. in a lab muffle furnace for thirty minutes to create Examples 1-5. The samples were removed from the furnace and cooled to room temperature in ambient air. The samples were tested, and the test results showed that the compaction strength of the perlite microspheres may be increased up to thirty-three times after heat-treatment relative to samples that have not been heat-treated. As shown in FIGS. 1 and 2 SEM Micrograph analysis of the pre-heat-treated and heat-treated samples, respectively, confirms that at least some surface flaws (e.g., cracks and pores) on the microsphere surface were reduced or removed as a result of heat-treatment.

The strength of the perlite microspheres was determined by a compaction strength test. One-inch compaction strength measures compressive force required to reduce a specified five-inch column of perlite microspheres by one inch. A Dillion TC² Tension Compression Cyclic machine was used for the measurement. The sample perlite microspheres tested were packed into a test cylinder with a 1⅛ inch inside diameter and a five-inch inside depth. The filled test cylinder was then held on a platform of a tamped density before compaction machine and bounced twenty-five times. After fitting a flanged collar on the test cylinder, more of a given sample was added to bring the height to within an inch of the top of the collar. The filled test cylinder was then bounced for an additional twenty-five times. After removing the collar, the sample above the level of the test cylinder was struck off with a straight edge. The cylinder with samples was then weighed for a tamped density before compaction measurement before the compaction strength test.

During the compaction strength test, the cylinder a slowly compressed with a piston at a speed of two inches per minute down to the one-inch mark. The resistance of the perlite microsphere sample (i.e., the total force divided by the piston area) during the compaction was then used as the one-inch compaction strength in pounds per square inch (psi). The results of the test of the untreated Harborlite® 50×50 and Examples 1-5 are shown in Table 1 below. As seen in Table 1, the exemplary heat-treatment resulted in significant gains in the measured one-inch compaction strength relative to the untreated Harborlite® 50×50 sample.

TABLE 1

| | | | Tamped density | |
|---|---|---|---|---|
| | | | before | One-Inch |
| | Temperature | Time | compaction | Compaction |
| Sample ID | (° C.) | (min.) | (lb/cf) | Strength (psi) |
| Harborlite ® | | | 2.9 | 3.9 |
| 50 × 50 | | | | |
| Example 1 | 800 | 30 | 4.0 | 6.3 |
| Example 2 | 900 | 30 | 3.9 | 7.8 |
| Example 3 | 950 | 30 | 6.6 | 18.0 |
| Example 4 | 975 | 30 | 9.6 | 34.5 |
| Example 5 | 1000 | 30 | 16.2 | 130.0 |

In a test of a second set of samples, commercially available perlite microsphere product samples (Europel® B-6, available from Imerys) were reacted with boric acid at temperatures ranging from 850° C. to 1000° C. in a lab muffle furnace for thirty minutes to create Examples 6-11. After thirty minutes of heat-treatment, the reacted samples were removed from the furnace and cooled to room temperature in ambient air. After cooling, the samples were tested for two-inch compaction strength according to the procedure outlined above except with a two-inch compaction distance instead of a one-inch compaction distance, with the test results shown below in Table 2. As seen in Table 2, the exemplary heat-treatment and surface-treatment resulted in significant gains in the measured two-inch compaction strength relative to the untreated Europerl® B-6 sample.

TABLE 2

| | | | | | Tamped density |
|---|---|---|---|---|---|
| | Boric | Temperature | Time | Two-inch Compaction | before compaction |
| Sample ID | acid (%) | (° C.) | (min) | Resistance (psi) | (pcf) |
| Europerl ® | | | | 16 | 3.3 |
| B-6 | | | | | |
| Example 6 | 10 | 850 | 30 | 26 | 3.6 |
| Example 7 | 10 | 900 | 30 | 38 | 4.9 |
| Example 8 | 10 | 950 | 30 | 87 | 9.5 |
| Example 9 | 10 | 1000 | 30 | >600 (OL) | 27.4 |
| Example 10 | 15 | 950 | 30 | 124 | 12.0 |
| Example 11 | 20 | 950 | 30 | 223 | 16.0 |

Without wishing to be bound by theory, it is believed that the increased compaction strength of the heat-treated and boric acid-treated perlite microspheres may result from the formation of Si—O—B bonds. An XRD full scan confirmed the structure of the perlite microspheres was still amorphous after the reaction with boric acid, and an FTIR spectra showed the formation of Si—O—B bonding, which indicates boron was incorporated into the glass network of the perlite microspheres to form boron aluminosilicate glass, which is known for high mechanical strength, thermal stability, and chemical durability.

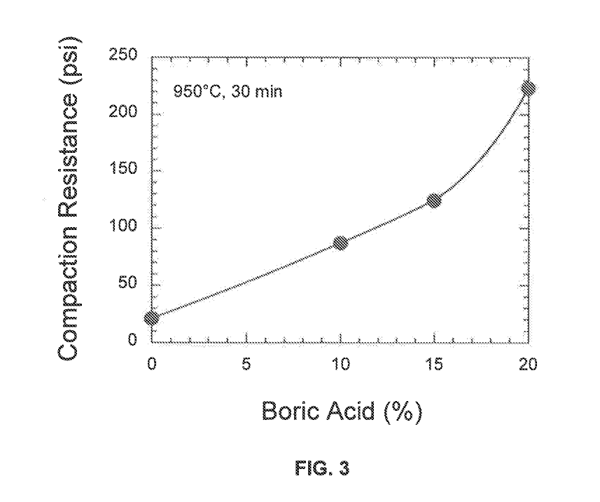

FIG. 3 shows the increase in compaction resistance as a function of the boric acid concentration of the treated perlite microsphere samples that have been heat-treated and surface-treated with boric acid. As shown in FIG. 3, the compaction resistance has been surprisingly and dramatically increased by heat-treatment at 950° C. for thirty minutes as the boric acid concentration increases from zero to 20%.

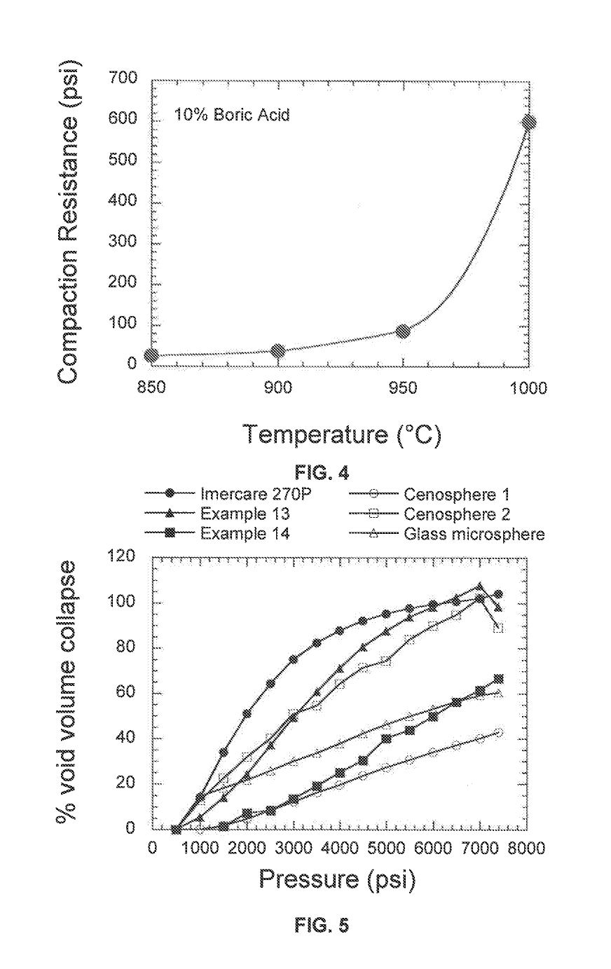

FIG. 4 shows the increase in compaction resistance as a function of the temperature of the heat-treatment of the treated perlite microsphere samples that have been heat-treated and surface-treated with boric acid. As shown in FIG. 4, the compaction resistance has been surprisingly and dramatically increased by heat-treatment ranging from 850° C. to 1000° C. for thirty minutes and treatment with a 10% boric acid concentration.

Three more samples were prepared and tested for compaction strength. In the first sample, Example 12, a commercially available perlite microsphere product (Imercare® 400P, available from Imerys) was heat-treated at 900° C. in a lab muffle furnace for fifteen minutes. Following heat-treatment, the sample was removed from the furnace and cooled to room temperature in ambient air. After cooling, the half-inch compaction strength of Example 12 was determined by the compaction strength test previously outlined, except with a half-inch compaction distance. The half-inch compaction strength of the heat-treated perlite microspheres increased about 47% relative to a non-heat-treated control sample.

In a second sample, Example 13, a commercially available perlite microsphere product (Imercare® 270P, available from Imerys) was screened through a 100 mesh having 150 micron openings. The screened sample was heat-treated at 900° C. in a lab muffle furnace for fifteen minutes. After the heat-treatment, the sample was removed from the furnace and cooled to room temperature in ambient air. After cooling, the half-inch compaction strength of Example 13 was determined by the compaction strength test previously outlined, except with a half-inch compaction distance. The half-inch compaction strength of the heat-treated perlite microspheres increased about 68% relative to a non-heat-treated control sample.

In a third sample, Example 14, a commercially available perlite microsphere product (Imercare® 270P, available from Imerys) was screened through a 140 mesh having with 105 micron openings. The screened sample was heat-treated at 900° C. in a lab muffle furnace for fifteen minutes. After heat-treatment, the sample was removed from the furnace and cooled to room temperature in ambient air. After cooling, 50 grams of the heat-treated sample was coated with a solution with 24.4 grams of water, 7.5 grams of sodium silicate, and 1.9 grams of aluminum sulfate (Al₂(SO₄)₃). The coated sample was dispersed through a 10 mesh screen having 1.70 mm openings and then dried in an oven at 150° C. The dried sample was thereafter screened through a 140 mesh again. Thereafter, the half-inch compaction strength of the screened sample of Example 14 was determined by the compaction strength test previously outlined, except with a half-inch compaction distance. The half-inch compaction strength of the heat-treated and surface-treated perlite microspheres was measured as increasing about 68% relative to a non-heat-treated and non-surface-treated control sample, although this measurement underreports the increase in compaction strength because the pressure required for compaction of the heat-treated and surface-treated sample was higher than the instrument limit.

The samples of Examples 13 and 14 were further tested for isostatic crush strength according to ASTM D3102 (Practice for Determination of Isostatic Collapse Strength of Hollow Glass Microspheres). A commercial synthetic glass microsphere product and two commercial cenosphere products (Cenosphere 1 and Cenosphere 2) were also tested for comparison.

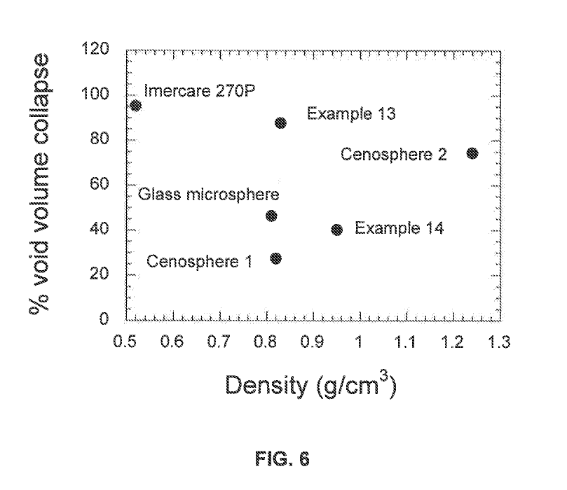

Tables 3 and 4 below show the test results, which indicate that both the heat-treating and surface-treating processes improve the isostatic crush strength. FIG. 5 shows the percentage of void volume (% void volume) collapse as a function of pressure according to the test results shown in Table 4. FIG. 6 shows the percentage of void volume collapse and density at a pressure of 5000 pounds per square inch (psi) according to the test results shown in Table 4.

As can be seen by the test results, the crush strength of Example 14 (both heat-treated and surface-treated) is significantly higher than the commercial Cenosphere 1 sample and slightly higher than synthetic glass microsphere sample. As shown in FIG. 6, at a pressure of 5000 psi, Example 14 had lower percentage of void volume (% void volume) collapse than the commercial synthetic glass microsphere. Compared to commercial Cenosphere 2, Example 14 had a lower density and percentage of void volume collapse.

TABLE 3

| | | | 0.5-inch | Tamped density |
|---|---|---|---|---|
| | Temperature | Time | compaction | before compaction |
| Sample ID | (° C.) | (min) | resistance | (pcf) |
| Imercare ® | | | 110 | 11.6 |
| 400 P | | | | |
| Example 12 | 900 | 15 | 162 | 15.5 |
| Imercare ® | | | 380 | 17.2 |
| 270 P | | | | |
| Example 13 | 900 | 15 | >640 (OL) | 23.1 |
| Example 14 | 900 | 15 | >640 (OL) | 25.3 |

TABLE 4

| Pressure | | | Glass | Imercare ® | | |
|---|---|---|---|---|---|---|
| (psi) | Cenosphere 1 | Cenosphere 2 | Microsphere | 270P | Example 13 | Example 14 |
| 500.25 | 0 | 0 | 0 | 0 | 0 | 0 |
| 999.05 | −0.03 | 12.73 | 14.66 | 14.21 | 5.44 | −0.06 |
| 1499.3 | 1.76 | 22.47 | 18.12 | 33.98 | 13.9.8 | 1.49 |
| 1998.1 | 4.7 | 31.86 | 21.79 | 51.04 | 24.22 | 7.4 |
| 2498.35 | 8.53 | 40.08 | 25.88 | 64.44 | 37.11 | 8.34 |
| 2997.15 | 12.15 | 50.78 | 30.06 | 75.07 | 49.25 | 13.51 |
| 3497.4 | 16.13 | 54.54 | 33.65 | 82.34 | 60.78 | 19.15 |
| 3997.65 | 19.56 | 64.25 | 37.84 | 87.76 | 71.24 | 25.07 |
| 4496.45 | 23.67 | 71.56 | 42.3 | 92.25 | 80.77 | 30.47 |
| 4996.7 | 27.42 | 74.53 | 46.37 | 95.29 | 87.64 | 40.14 |
| 5495.5 | 30.55 | 83.97 | 49.86 | 97.74 | 93.96 | 43.79 |
| 5995.75 | 34.03 | 89.96 | 53.24 | 99.53 | 98.22 | 49.91 |
| 6496 | 37.1 | 94.87 | 56.44 | 100.8 | 102.6 | 56.24 |
| 7000.6 | 40.06 | 102.27 | 59.29 | 102.17 | 107.65 | 61.58 |
| 7395 | 42.72 | 89.22 | 60.53 | 104.2 | 98.34 | 66.63 |

Other embodiments of the invention will be apparent to those skilled in the art from consideration of the specification and practice of the invention disclosed herein. It is intended that the specification and examples be considered as exemplary only, with a true scope and spirit of the invention being indicated by the following claims,

1. A method for strengthening perlite microspheres, the method comprising:
providing a plurality of perlite microspheres; and
heating the plurality of perlite microspheres at a temperature of at least about 600° C. for at least about five minutes to form strengthened perlite microspheres,

2-4. (canceled)

5. The method of claim 1, further comprising adding at least one metal component and at least one silicate component to the plurality of perlite microspheres to form a plurality of metal silicate-coated perlite microspheres.

6. The method of claim 5, wherein the at least one metal component is selected from the group consisting of metal nitrates, metal sulfates, metal aluminates, sodium metals, metal chlorides, metal alkoxides, metal acetates, metal formates, bayerite, pseudoboehmite, gibbsite, colloidal metals, metal gels, metal sols, metal trichlorides, ammonium metal carbonates, metal hydrates, and metal chlorohydrates.

7-8. (canceled)

9. The method of claim 5, wherein adding at least one metal component and at least one silicate component occurs prior to heating the plurality of perlite microspheres.

10. (canceled)

11. The method of claim 1, wherein the perlite microspheres have a one-inch compaction strength prior to being strengthened, and wherein the strengthened perlite microspheres have a one-inch compaction strength at least twice the one-inch compaction strength of the perlite microspheres prior to being strengthened.

12-14. (canceled)

15. The method of claim 1, further comprising, prior to heating the plurality of perlite microspheres:
providing perlite particles; and
heating the perlite particles to form a plurality of perlite microspheres.

16. A composition comprising the strengthened perlite microspheres formed from the method of claim 1.

17. At least one of a drilling fluid and a well cement comprising a slurry comprising:
at least one fluid; and
the composition of claim 16.

18. A slurry for use as at least one of a drilling fluid and a well cement, the slurry comprising:
at least one fluid; and
a plurality of perlite microspheres, wherein the plurality of perlite microspheres have been strengthened by at least one of:
heating the plurality of perlite microspheres at a temperature of at least about 600° C. for at least about five minutes to provide heat-treated perlite microspheres having reduced surface flaws relative to the perlite microspheres prior to heat treating; and
adding at least one metal component and at least one silicate component to the plurality of perlite microspheres to form a plurality of metal silicate-coated perlite microspheres.

19. The slurry of claim 18, wherein the at least one metal component is selected from the group consisting of metal nitrates, metal sulfates, metal aluminates, sodium metals, metal chlorides, metal alkoxides, metal acetates, metal formates, bayerite, pseudoboehmite, gibbsite, colloidal metals, metal gels, metal sols, metal trichlorides, ammonium metal carbonates, metal hydrates, and metal chlorohydrates.

20. The slurry of claim 18, wherein the at least one metal component comprises at least one of aluminum, boron, lithium, zinc, and zirconium.

21. The slurry of claim 18, wherein the at least one silicate component is selected from the group consisting of tetraethylorthosilicate, tetramethylorthosilicate, sodium silicate, alkali silicate, colloidal silica, solid silica, alkaline metal silicates, and sodium metasilicate.

22. The slurry of claim 18, wherein the plurality of strengthened perlite microspheres have a one-inch compaction strength of at least 5 pounds per square inch.

23-26. (canceled)

27. The slurry of claim 18, wherein the plurality of strengthened perlite microspheres have a tamped density before compaction of at least 4 pounds per cubic foot.

28-30. (canceled)

31. Treated perlite microspheres, wherein the treated perlite microspheres are at least one of:
heat-treated perlite microspheres heated at a temperature of at least about 600° C. for at least about five minutes to provide heat-treated perlite microspheres having reduced surface flaws relative to the perlite microspheres prior to heat treating; and
surface-treated perlite microspheres comprising a plurality of metal silicate-coated perlite microspheres,
wherein the treated perlite microspheres have a density of less than 1.5 grams per cubic centimeter and a crush strength of less than 50% volume collapsed at 10000 pounds per square inch.

32-34. (canceled)

35. The treated perlite microspheres of claim 31, wherein the treated perlite microspheres comprise surface-treated perlite microspheres, and wherein the metal silicate coating comprises at least one metal component selected from the group consisting of metal nitrates, metal sulfates, metal aluminates, sodium metals, metal chlorides, metal alkoxides, metal acetates, metal formates, bayerite, pseudoboehmite, gibbsite, colloidal metals, metal gels, metal sols, metal trichlorides, ammonium metal carbonates, metal hydrates, and metal chlorohydrates.

36. The treated perlite microspheres of claim 31, wherein the treated perlite microspheres comprise surface-treated perlite microspheres, and wherein the metal silicate coating comprises at least one metal component comprising at least one of aluminum, boron, lithium, zinc, and zirconium.

37. The treated perlite microspheres of claim 31, wherein the treated perlite microspheres comprise surface-treated perlite microspheres, and wherein the metal silicate coating comprises at least one silicate component selected from the group consisting of tetraethylorthosilicate, tetramethylorthosilicate, sodium silicate, alkali silicate, colloidal silica, solid silica, alkaline metal silicates, and sodium metasilicate.

38. The treated perlite microspheres of claim 31, wherein the treated perlite microspheres have a one-inch compaction strength of at least 5 pounds per square inch.

39. (canceled)

40. The treated perlite microspheres of claim 31, wherein the treated perlite microspheres have a one-inch compaction strength of at least 20 pounds per square inch.

41-57. (canceled)
